(19) United States
(12) Patent Application Publication
(10) Pub. No.: US 2025/0072521 A1
(43) Pub. Date: Mar. 6, 2025

(54) AEROSOL GENERATING DEVICE

(71) Applicant: KT&G CORPORATION, Daejeon (KR)

(72) Inventors: Yong Hwan KIM, Gyeonggi-do (KR); Young Bum KWON, Gyeonggi-do (KR); Dong Sung KIM, Seoul (KR); Hun ll LIM, Seoul (KR)

(73) Assignee: KT&G CORPORATION, Daejeon (KR)

(21) Appl. No.: 18/574,905

(22) PCT Filed: Aug. 17, 2023
(86) PCT No.: PCT/KR2023/012175

§ 371 Date: Dec. 28, 2023

(30) Foreign Application Priority Data
Sep. 5, 2022 (KR) 10-2022-0112371
Jan. 31, 2023 (KR) 10-2023-0013015

(51) Int. Cl. A24F 40/57; A24F 40/20; A24F 40/465; A24F 40/51; A24F 40/53; A24F 40/65

(52) U.S. Cl. CPC A24F 40/57; A24F 40/20; A24F 40/465; A24F 40/51; A24F 40/53; A24F 40/65

(57) ABSTRACT

An aerosol generating device includes a battery, an induction coil configured to generate an alternating magnetic field on the basis of power supplied from the battery, a susceptor configured to heat an aerosol generating substrate by using heat generated by the alternating magnetic field, a temperature sensor arranged adjacent to the susceptor and configured to output a temperature sensing value as detection information, and a controller configured to cut off power supplied to the induction coil, according to a first abnormal heating condition and a second abnormal heating condition, which are based on the detection information of the temperature sensor.

### TECHNICAL FIELD

The disclosure relates to an aerosol generating device, and more particularly, to an aerosol generating device capable of preventing abnormal heating of a heating element.

### BACKGROUND ART

Recently, the demand for alternative methods to overcome the shortcomings of general cigarettes has increased. For example, there is an increasing demand for a method of generating aerosol by heating an aerosol generating material in cigarettes or liquid storages (e.g., cartridges), rather than by burning cigarettes.

Meanwhile, aerosol generating devices control heating elements on the basis of sensing values. However, when errors occur in sensing values (e.g., cigarette sensing values, temperature sensing values, and the like), abnormal heating may occur in which temperatures of heating elements are higher or lower than target temperatures. When abnormal heating as described above occurs, user dissatisfaction occurs due to the possibility of power consumption or the failure to exhibit expected performance.

### DISCLOSURE OF INVENTION

### Technical Problem

Technical problems to be solved by the disclosure are to provide an aerosol generating device capable of preventing abnormal heating of a heating element.

The technical problems of the disclosure are not limited to the aforementioned description, and other technical problems may be derived from the embodiments described hereinafter.

### Solution to Problem

According to an aspect of the disclosure, an aerosol generating device includes a battery, an induction coil configured to generate an alternating magnetic field on the basis of power supplied from the battery, a susceptor configured to heat an aerosol generating substrate by using heat generated by the alternating magnetic field, a temperature sensor arranged adjacent to the susceptor and configured to output a temperature sensing value as detection information, and a controller configured to cut off power supplied to the induction coil according to a first abnormal heating condition and a second abnormal heating condition based on the detection information of the temperature sensor.

### Advantageous Effects of Invention

An aerosol generating device of the disclosure may significantly prevent power consumption by immediately cutting off power supplied to a heating element when abnormal heating of the heating element occurs due to an error in a sensing value.

Also, the aerosol generating device of the disclosure may detect, via a temperature sensing value, an abnormal heating state in which the heating element is heated while an aerosol generating substrate is not inserted. In addition, when detecting an abnormal heating state in which the heating element is heated while the aerosol generating substrate is not inserted, the aerosol generating device may significantly prevent power consumption by immediately cutting off power.

In addition, the aerosol generating device of the disclosure may detect a failure of a temperature sensor via a temperature sensing value and a power sensing value. In addition, when detecting the failure of the temperature sensor, the aerosol generating device may prevent the failure of internal components due to overheating of the aerosol generating device by immediately cutting off power.

The effects of the disclosure are not limited by the above illustrated description, and more various effects are included herein.

### BRIEF DESCRIPTION OF DRAWINGS

FIG. 1 is a block diagram illustrating an aerosol generating system according to an embodiment.

FIG. 2 is a view illustrating an aerosol generating substrate according to an embodiment.

FIG. 3 is a block diagram illustrating hardware components of an aerosol generating device, according to an embodiment.

FIG. 4 is a view illustrating an arrangement of a substrate detection sensor according to an embodiment.

FIG. 5 is a view illustrating an arrangement of a temperature sensor according to an embodiment.

FIG. 6 is a view illustrating an error in a temperature sensing value, according to an embodiment.

FIG. 7 is a graph illustrating points in time of determining a first abnormal heating condition and a second abnormal heating condition, according to an embodiment.

FIG. 8 is a flowchart illustrating an operation method of an aerosol generating device, according to an embodiment.

### BEST MODE FOR CARRYING OUT THE INVENTION

According to an aspect of the disclosure, an aerosol generating device includes a battery, an induction coil configured to generate an alternating magnetic field on the basis of power supplied from the battery, a susceptor configured to heat an aerosol generating substrate by using heat generated by the alternating magnetic field, a temperature sensor arranged adjacent to the susceptor and configured to output a temperature sensing value as detection information, and a controller configured to cut off power supplied to the induction coil according to a first abnormal heating condition and a second abnormal heating condition based on the detection information of the temperature sensor.

The controller may be configured to control the power supplied to the induction coil according to a temperature profile including a preheating section and a smoking section and cut off, in at least a partial section of the preheating section, the power supplied to the induction coil on the basis of the first abnormal heating condition.

The controller may be configured to cut off the power supplied to the induction coil on the basis of the second heating condition, in the preheating section and the smoking section.

The controller may be configured to cut off the power supplied to the induction coil, according to the first abnormal heating condition, when a temperature acquired from the temperature sensor within a preset reference time reaches a preset heating temperature.

The second abnormal heating condition may include a first sub-condition and a second sub-condition, and the controller may be configured to cut off the power supplied to the induction coil when at least one of the first sub-condition and the second sub-condition is satisfied.

The controller may be configured to cut off the power supplied to the induction coil, according to the first sub-condition when the temperature acquired from the temperature sensor is less than or equal to a preset maintenance temperature.

The preset maintenance temperature may be set to be lower than a target temperature of the susceptor according to a temperature profile.

The controller may be configured to cut off the power supplied to the induction coil, according to the second sub-condition when the power supplied to the induction coil is greater than or equal to preset reference power.

The preset reference power may be set to be higher than target power to be supplied to the induction coil to allow a temperature of the susceptor to a target temperature.

The susceptor may be formed to surround an outer circumferential surface of a cavity into which the aerosol generating substrate is inserted.

The temperature sensor may include a first wire, a second wire, and a contact element contacting the first wire and the second wire.

The first wire and the second wire may be spaced apart from each other to contact the contact element, and the contact element may contact an outer circumferential surface of the susceptor.

The aerosol generating device may further include a substrate detection sensor having an inductance varying when the aerosol generating substrate including an electromagnetic inductor is inserted into a cavity, wherein the controller is configured to determine whether or not the aerosol generating substrate is inserted into the cavity, on the basis of a detection result of the substrate detection sensor.

The aerosol generating device further include an output unit configured to output a first user notification and a second user notification, respectively, when the power supplied to the induction coil is cut off according to the first abnormal heating condition and the second abnormal heating condition.

Output patterns of the first user notification and the second user notification may be set to be different from each other.

### MODE FOR THE INVENTION

With respect to the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the disclosure. Therefore, the terms used in the various embodiments of the disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described herein mean units for processing at least one function and operation and may be implemented by hardware components or software components and combinations thereof.

Hereinafter, the disclosure will now be described more fully with reference to the accompanying drawings, in which example embodiments are shown such that one of ordinary skill in the art may easily work the disclosure. The disclosure may, however, be embodied in many different forms and should not be construed as being limited to the embodiments set forth herein.

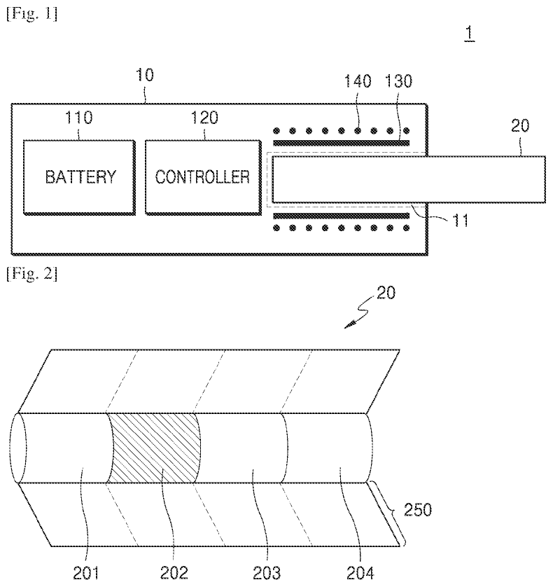

FIG. 1 is a block diagram illustrating an aerosol generating system according to an embodiment.

Referring to FIG. 1, an aerosol generating system 1 may include an aerosol generating device 10 and an aerosol generating substrate 20. Hereinafter, the aerosol generating substrate 20 may be referred to as a cigarette. The aerosol generating device 10 may include a cavity 11 into which the aerosol generating substrate 20 is inserted, and may generate aerosol by heating the aerosol generating substrate 20 inserted into the cavity 11. The aerosol generating substrate 20 may include an aerosol generating material.

The aerosol generating device 10 may include a battery 110, a controller 120, a susceptor 130, and an induction coil 140. However, the internal structure and arrangement of the aerosol generating device 10 are not limited to those illustrated in FIG. 1. It will be understood by one of ordinary skill in the art related to the present embodiment that, according to the design of the aerosol generating device 10, some of the hardware components illustrated in FIG. 1 may be omitted or new components may be further added, and each hardware component may be implemented in various arrangements.

The aerosol generating device 10 may generate aerosol by heating the aerosol generating substrate 20 accommodated in the aerosol generating device 10 in an induction heating method. The induction heating method may refer to a method of generating heat to a magnetic body by applying an alternating magnetic field having a periodically changing direction to the magnetic body generating heat by an external magnetic field.

When the alternating magnetic field is applied to the magnetic body, energy loss due to eddy current loss and hysteresis loss may occur in the magnetic body, and the lost energy may be released from the magnetic body as thermal energy. When the amplitude or frequency of the alternating magnetic field applied to the magnetic body increases, more thermal energy may be released from the magnetic body. The aerosol generating device 10 may release thermal energy from the magnetic body by applying the alternating magnetic field to the magnetic body and transfer, to the aerosol generating substrate 20, the thermal energy released from the magnetic body.

The magnetic body, which generates heat by the external magnetic field, may be a susceptor. The susceptor 130 may be provided in the aerosol generating device 10 in a shape such as a piece, a thin piece, or a strip. For example, at least a portion of the susceptor 130 arranged inside the aerosol generating device 10 may be formed of a susceptor material.

At least a portion of the susceptor material may be formed of a ferromagnetic substance. For example, the susceptor material may include metal or carbon. The susceptor material may include at least one of ferrite, ferromagnetic alloy, stainless steel, and aluminum (Al). In addition, the susceptor material may include at least one of ceramic such as graphite, molybdenum, silicon carbide, niobium, nickel alloy, metal film, or zirconia, transition metal such as nickel (Ni) or cobalt (Co), and metalloid such as boron (B) or phosphorus (P).

The aerosol generating device 10 may accommodate the aerosol generating substrate 20. The aerosol generating device 10 may include formed therein the cavity 11 for accommodating the aerosol generating substrate 20. The susceptor 130 may have a tubular or cylindrical shape, and may be arranged outside the cavity 11 to surround the cavity 11 into which the aerosol generating substrate 20 is inserted. Therefore, when the aerosol generating substrate 20 is inserted into the cavity 11 of the aerosol generating device 10, the susceptor 130 may be arranged outside the aerosol generating substrate 20 to surround the aerosol generating substrate 20. Accordingly, a temperature of an aerosol generating material in the aerosol generating substrate 20 may be increased by heat transferred from the susceptor 130.

The susceptor 130 may heat the aerosol generating substrate 20 accommodated in the aerosol generating device 10. As described above, the susceptor 130 may heat the aerosol generating substrate 20 in an induction heating method. The susceptor 130 may include the susceptor material that generates heat by the external magnetic field, and the aerosol generating device 10 may apply the alternating magnetic field to the susceptor 130.

The induction coil 140 may be provided in the aerosol generating device 10. The induction coil 140 may apply the alternating magnetic field to the susceptor 130. When power is supplied from the aerosol generating device 10 to the induction coil 140, a magnetic field may be formed inside the induction coil 140. When an alternating current (AC) is applied to the induction coil 140, a direction of the magnetic field formed inside the induction coil 140 may be continuously changed. When the susceptor 130 is located inside the induction coil 140 and is exposed to the alternating magnetic field having the periodically changing direction, the susceptor 130 may generate heat, and the aerosol generating substrate 20 accommodated in the cavity 11 may be heated.

The induction coil 140 may be wound along an outer surface of the susceptor 130. In addition, the induction coil 140 may be wound along an inner surface of an external housing of the aerosol generating device 10. The susceptor 130 may be located in an inner space formed by winding the induction coil 140. When power is supplied to the induction coil 140, the alternating magnetic field generated by the induction coil 140 may be applied to the susceptor 130.

The induction coil 140 may extend in a longitudinal direction of the aerosol generating device 10. The induction coil 140 may extend to an appropriate length in the longitudinal direction. For example, the induction coil 140 may extend to a length corresponding to a length of the susceptor 130, or may extend to a length longer than a length of the susceptor 130.

The induction coil 140 may be arranged at a location appropriate for applying the alternating magnetic field to the susceptor 130. For example, the induction coil 140 may be arranged at a location corresponding to the susceptor 130. The efficiency of applying the alternating magnetic field of the induction coil 140 to the susceptor 130 may be improved by the size and arrangement of the induction coil 140.

When the amplitude or frequency of the alternating magnetic field formed by the induction coil 140 changes, the degree to which the susceptor 130 heats the aerosol generating substrate 20 may also change. The amplitude or frequency of the alternating magnetic field formed by the induction coil 140 may be changed by power applied to the induction coil 140, and thus, the aerosol generating device 10 may control heating of the aerosol generating substrate 20 by adjusting the power applied to the induction coil 140. For example, the aerosol generating device 10 may control the amplitude and frequency of an AC applied to the induction coil 140.

As an example, the induction coil 140 may be implemented as a solenoid. The induction coil 140 may be a solenoid wound along the inner surface of the outer housing of the aerosol generating device 10, and the susceptor 130 and the aerosol generating substrate 20 may be located in an inner space of the solenoid. A material of a conductive wire constituting the solenoid may be copper (Cu). However, the material of the conductive wire constituting the solenoid is not limited thereto and may include any one of silver (Ag), gold (Au), aluminum (Al), tungsten (W), zinc (Zn), and nickel (Ni), or an alloy including at least one thereof.

The battery 110 may supply power to the induction coil 140. The battery 110 may be a lithium iron phosphate (LiFePO₄) battery, but is not limited thereto. For example, the battery 110 may be a lithium cobalt oxide (LiCoO₂) battery, a lithium titanium battery, a lithium polymer (LiPoly) battery, or the like.

The controller 120 may control power supplied to the induction coil 140. The controller 120 may control the battery 110 so that the power supplied to the induction coil 140 is adjusted. For example, the controller 120 may control the power supplied to the induction coil 140 so that the susceptor 130 maintains a target temperature.

Meanwhile, although not illustrated in FIG. 1, the aerosol generating device 10 may constitute a system together with a separate cradle. For example, the cradle may be used to charge the battery 110 of the aerosol generating device 10. Alternatively, the induction coil 140 may be heated while the cradle and the aerosol generating device 10 are coupled to each other.

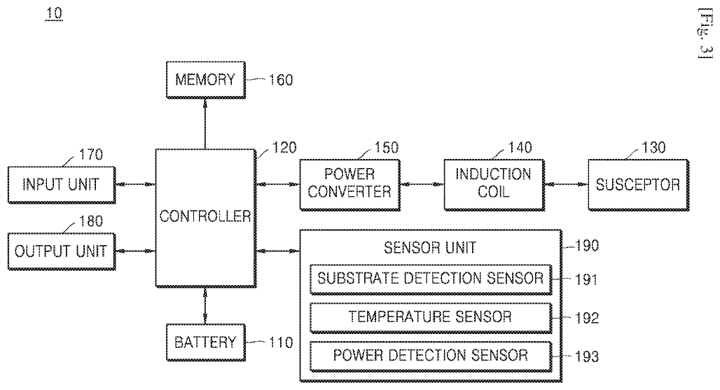

FIG. 2 is a view illustrating an aerosol generating substrate according to an embodiment.

Referring to FIG. 2, an aerosol generating substrate 20 may correspond to the cigarette of FIG. 1. The aerosol generating substrate 20 may be divided into a first portion 201, a second portion 202, a third portion 203, and a fourth portion 204, and the first portion 201, the second portion 202, the third portion 203, and the fourth portion 204 may include an aerosol generating element, a tobacco element, a cooling element, and a filter element, respectively. In detail, the first portion 201 may include an aerosol generating material, the second portion 202 may include a tobacco material and a moisturizer, the third portion 203 may include a unit for cooling an airflow passing through the first portion 201 and the second portion 202, and the fourth portion 204 may include a filter material.

The first portion 201, the second portion 202, the third portion 203, and the fourth portion 204 may be arranged in order on the basis of a longitudinal direction of the aerosol generating substrate 20. Here, the longitudinal direction of the aerosol generating substrate 20 may be a direction in which a length of the aerosol generating substrate 20 extends. For example, the longitudinal direction of the aerosol generating substrate 20 may be a direction from the first portion 201 toward the fourth portion 204. Accordingly, aerosol generated in at least one of the first portion 201 and the second portion 202 may form an airflow by sequentially passing through the first portion 201, the second portion 202, the third portion 203, and the fourth portion 204, and thus, the user may inhale the aerosol from the fourth portion 204.

The first portion 201 may include an aerosol generating element. The first portion 201 may include, in addition to the aerosol generating element, other additives as flavors, a wetting agent, and/or organic acid, and may include a flavoring liquid such as menthol or a moisturizer. Here, the aerosol generating element may include, for example, at least one of glycerin, propylene glycol, ethylene glycol, dipropylene glycol, diethylene glycol, triethylene glycol, tetraethylene glycol, and oleyl alcohol.

The first portion 201 may include a crimped sheet, and the aerosol generating element may be included in the first portion 201 while being impregnated into the crimped sheet. In addition, the other additives, such as flavors, a wetting agent, and/or organic acid, and the flavoring liquid may be included in the first portion 201 while being absorbed into the crimped sheet. The crimped sheet may be a sheet including a polymer material. For example, the polymer material may include at least one of paper, cellulose acetate, lyocell, and polylactic acid. For example, the crimped sheet may be a paper sheet that does not generate an off-flavor due to heat even when heated at a high temperature. However, the disclosure is not limited thereto.

The first portion 201 may extend from an end of the aerosol generating substrate 20 to a point of about 7 mm to about 20 mm, and the second portion 202 may extend from an end of the first portion 201 to a point of about 7 mm to about 20 mm. However, the extension lengths of the first portion 201 and the second portion 202 are not limited to the above numerical range, and the extension length of each of the first portion 201 and the second portion 202 may be appropriately adjusted within a range that may be easily changed by one of ordinary skill in the art.

The second portion 202 may include a tobacco element. The tobacco element may include a particular form of tobacco material. For example, the tobacco element may have the form of cut tobacco leaves, tobacco particles, a tobacco sheet, tobacco beads, tobacco granules, tobacco powder, or tobacco extracts. In addition, the tobacco material may include, for example, at least one of tobacco leaves, tobacco leaf veins, expanded tobacco, cut leaves, reconstituted tobacco leaves, and reconstructed tobacco. The third portion 203 may include a unit for cooling the airflow passing through the first portion 201 and the second portion 202. The third portion 203 may include a polymer material or a biodegradable polymer material, and may have a cooling function. For example, the third portion 203 may include a polylactic acid (PLA) fiber, but is not limited thereto. Alternatively, the third portion 203 may include a cellulose acetate filter in which a plurality of pores are perforated. However, the third portion 203 is not limited to the above example, and may include any material that performs a function of cooling aerosol without limitation. For example, the third portion 203 may include a tube filter or a paper tube filter including a hollow.

The fourth portion 204 may include a filter material. For example, the fourth portion 204 may include a cellulose acetate filter. Meanwhile, a shape of the fourth portion 204 is not limited. For example, the fourth portion 204 may include a cylinder-type rod or a tube-type rod having a hollow inside. In addition, the fourth portion 204 may include a recess-type rod. When the fourth portion 204 includes a plurality of segments, at least one of the plurality of segments may be manufactured in a different shape.

The fourth portion 204 may be manufactured to generate flavor. For example, a flavoring liquid may be injected onto the fourth portion 204, or an additional fiber coated with a flavoring liquid may be inserted into the fourth portion 204.

The aerosol generating substrate 20 may include a wrapper 250 surrounding at least some of the first portion 201 to the fourth portion 204. In addition, the aerosol generating substrate 20 may include the wrapper 250 surrounding all of the first portion 201 to the fourth portion 204. The wrapper 250 may be located on an outermost portion of the aerosol generating substrate 20, and the wrapper 250 may be a single wrapper, but may be a combination of a plurality of wrappers.

The wrapper 250 may be an electromagnetic inductor for detecting a cigarette by using a substrate detection sensor 191 of FIG. 3, and may include a heat conductive material. For example, the heat conductive material may be a metal foil such as silver (Ag) foil, aluminum (Al) foil, or copper (Cu) foil, but is not limited thereto. The heat conductive material included in the wrapper 250 may improve heat conductivity by evenly dispersing heat transferred to the first portion 201 and the second portion 202, and thus may improve the taste of tobacco. In addition, the heat conductive material included in the wrapper 250 may also function as a susceptor.

The heat conductive material of the wrapper 250 may change an inductance of the substrate detection sensor 191. On the basis of the change in inductance detected by the substrate detection sensor 191, the aerosol generating device 10 of FIG. 1 may determine whether or not the aerosol generating substrate 20 is inserted into or extracted from the aerosol generating device 10 of FIG. 1.

FIG. 3 is a block diagram illustrating hardware components of an aerosol generating device, according to an embodiment.

Referring to FIG. 3, an aerosol generating device 10 may include a battery 110, a susceptor 130, an induction coil 140, a power converter 150, a memory 160, an input unit 170, an output unit 180, and a sensor unit 190. FIG. 3 illustrates that the aerosol generating device 10 includes components related to the present embodiment. Therefore, it may be understood by one of ordinary skill in the art related to the present embodiment that the aerosol generating device 10 may further include other general-purpose components, in addition to the components illustrated in FIG. 3.

Meanwhile, the operations of the aerosol generating device 10 described with reference to FIG. 1 may also be applied to the aerosol generating device 10 of FIG. 3.

The battery 110 supplies power used to operate the aerosol generating device 10. In other words, the battery 110 may supply power to the induction coil 140 so that the susceptor 130 may be heated. The battery 110 may convert power via the power converter 150 and supply the converted power to the induction coil 140. In addition, the battery 110 may supply power needed for operations of other components provided in the aerosol generating device 10, i.e., the power converter 150, the memory 160, the input unit 170, the output unit 180, and the sensor unit 190. The battery 110 may be a rechargeable battery or a disposable battery.

The power converter 150 may be supplied with direct current (DC) power from the battery 110 and convert the DC power into AC power. Accordingly, the power converter 150 may include at least one switching element. In addition, the power converter 150 may include a filter element for filtering the DC power supplied from the battery 110 or filtering the AC power supplied to the induction coil 140. In addition, the power converter 150 may include an amplifier for amplifying the DC power supplied from the battery 110 and/or the AC power supplied to the induction coil 140. In an embodiment, the power converter 150 may be implemented as a class-D amplifier and/or a class-E amplifier.

The controller 120 may supply power to the induction coil 140 by controlling driving of at least one switching element provided in the power converter 150. For example, the controller 120 may control the power supplied to the induction coil 140 by controlling a driving frequency of switching elements included in the power converter 150, a duty of a current supplied to the induction coil 140, and the like. Here, the duty may refer to a ratio of a supply time of power supplied to the induction coil 140 within a switching period.

According to embodiments, the controller 120 may include a separate heating integrated circuit (IC) for controlling only power supply to the induction coil 140.

The induction coil 140 may be supplied with AC power from the power converter 150 to generate an alternating magnetic field. The induction coil 140 may heat the susceptor 130 by applying the alternating magnetic field having a periodically changing direction to the susceptor 130 on the basis of the AC power.

The susceptor 130 may be heated by the alternating magnetic field to heat an aerosol generating substrate. When the aerosol generating substrate is heated, aerosol may be generated.

The susceptor 130 may be provided in the aerosol generating device 10 in a shape such as a piece, a thin piece, or a strip. According to an embodiment, the susceptor 130 may be disposed on the aerosol generating substrate 20. The susceptor 130 may be formed of a ferromagnetic substance. For example, the susceptor 130 may include metal or carbon. The susceptor 130 may include at least one of ferrite, ferromagnetic alloy, stainless steel, and aluminum (Al). In addition, the susceptor 130 may include at least one of ceramic such as graphite, molybdenum, silicon carbide, niobium, a nickel alloy, a metal film, or zirconia, transition metal such as nickel (Ni) or cobalt (Co), and metalloid such as boron (B) or phosphorus (P).

The sensor unit 190 may sense various types of state information of the aerosol generating device 10. The result sensed by the sensor unit 190 may be transmitted to the controller 120, and the controller 120 may control the aerosol generating device 10 to perform various functions, such as controlling an operation of a heating unit (including an induction coil and a susceptor), limiting smoking, determining whether or not the aerosol generating substrate 20 is inserted, and displaying a notification, according to the sensing result.

The sensor unit 190 may include a substrate detection sensor 191, a temperature sensor 192, and a power detection sensor 193.

The substrate detection sensor 191 may detect whether or not the aerosol generating substrate 20 is inserted into the cavity 11. In an embodiment, the substrate detection sensor 191 may be implemented as an inductive sensor. The substrate detection sensor 191 may measure an amount of change in inductance that is changed due to a decrease or increase in a distance between the electromagnetic inductor provided in the aerosol generating substrate 20 and the inductive sensor when the aerosol generating substrate 20 is inserted into or extracted from the cavity 11. According to an embodiment, the substrate detection sensor 191 may be replaced with a different type of sensor such as an optical sensor or a resistive sensor.

The controller 120 may control the aerosol generating device 10 so that heating automatically starts without an additional external input when insertion of an aerosol generating article is detected. For example, the controller 120 may control the battery 110 to supply power to a coil when the insertion of the aerosol generating article is detected. However, the controller unit 120 is not limited thereto, and may control the aerosol generating device 10 so that heating starts only when an additional external input is present.

The temperature sensor 192 may detect a temperature of the susceptor 130. The temperature sensor 192 may contact the susceptor 130 and detect the temperature of the susceptor 130. For example, the temperature sensor 192 may be implemented as a thermocouple. When the temperature sensor 192 is implemented as the thermocouple, the temperature sensor 192 may have a fast response speed and a small error.

The controller 120 may control the temperature of the susceptor 130 on the basis of sensing information of the temperature sensor 192. The controller 120 may control power supplied to the induction coil 140 to maintain the temperature of the susceptor 130 at a target temperature according to a preset temperature profile.

The power detection sensor 193 may detect power applied to the induction coil 140. The power detection sensor 193 may be arranged between the power converter 150 and the induction coil 140 to detect an AC current and/or an AC voltage applied to the induction coil 140. For example, the power detection sensor 193 may be implemented as a shunt resistor.

The sensing information of the power detection sensor 193 may include instantaneous power, active power, average power, or the like supplied to the induction coil 140. The controller 120 may control power supplied to the induction coil 140 on the basis of the sensing information of the power detection sensor 193.

Meanwhile, FIG. 3 illustrates that the sensor unit 190 includes components related to the present embodiment. Therefore, it may be understood by one of ordinary skill in the art related to the present embodiment that the sensor unit 190 of the aerosol generating device 10 may further include other general-purpose components in addition to the components illustrated in FIG. 3. For example, the sensor unit 190 may further include a puff sensor for detecting a puff by a user, a water detection sensor for detecting water inside and/or outside the aerosol generating device 10, and the like.

The memory 160 may be hardware that stores various types of data processed in aerosol generating device 10, and the memory 160 may store pieces of data processed by controller 120 and pieces of data to be processed by the controller 120. The memory 160 may be implemented as various types, such as random access memory (RAM) such as dynamic random access memory (DRAM) or static random access memory (SRAM), read-only memory (ROM), and electrically erasable programmable read-only memory (EEPROM).

The memory 160 may store data regarding an operation time of the aerosol generating device 10, the maximum number of puffs, the current number of puffs, at least one temperature profile, and a smoking pattern of the user, and the like. In an embodiment, the memory 160 may store a reference value of an amount of change in inductance for determining whether or not the aerosol generating substrate 20 is inserted/extracted. In addition, the memory 160 may store a temperature reference value and a power reference value for determining an abnormality of the temperature sensor 192.

The input unit 170 may receive a user input. The input unit 170 may be implemented as a physical key and/or a touch sensor for receiving the user input. The aerosol generating device 10 of the disclosure may heat the susceptor 130 even without the user input when the substrate detection sensor 191 detects the aerosol generating substrate 20. According to an embodiment, the aerosol generating device 10 may heat the susceptor 130 on the basis of the user input.

The output unit 180 may include a display that outputs visual information related to the aerosol generating device 10. In addition, the output unit 180 may include a motor that outputs tactile information related to the aerosol generating device 10. Here, the visual information and the tactile information related to the aerosol generating device 10 include all information related to the operation of the aerosol generating device 10. For example, the display may output information regarding a state of the aerosol generating device 10 (e.g., whether or not the aerosol generating device 10 is usable or the like), information regarding the susceptor 130 (e.g., a preheating start, a preheating progress, a preheating completion, or the like), information related to the battery 110 (e.g., a remaining capacity of the battery 110, whether or not the battery 110 is usable, or the like), information related to reset of the aerosol generating device 10 (e.g., a reset timing, a reset progress, a reset completion, or the like), information related to cleaning of the aerosol generating device 10 (e.g., a cleaning timing, cleaning need, a cleaning progress, a cleaning completion, or the like), information related to charging of the aerosol generating device 10 (e.g., a charge need, a charge progress, a charge completion, or the like), information related to puffs (e.g., the number of puffs, a puff end notification, or the like), information related to safety (e.g., a use time elapse or the like), or the like.

The controller 120 controls the overall operation of the aerosol generating device 10. The controller 120 includes at least one processor. The processor may be implemented as an array of a plurality of logical gates, or a combination of a general-purpose micro-processor and a memory that stores programs that may be executed by the micro-processor. In addition, it may be understood by one of ordinary skill in the art to which the present embodiment belongs that the processor may be implemented as other types of hardware.

The controller 120 may determine abnormal heating of the aerosol generating device 10 from the sensing information of the sensor unit 190. The abnormal heating may include first abnormal heating in which the susceptor 130 is heated while the aerosol generating substrate 20 is not inserted into the cavity 11, and second abnormal heating occurring due to an error in a temperature sensing area.

The memory 160 may store a first abnormal heating condition for determining the first abnormal heating and a second abnormal heating condition for determining the second abnormal heating.

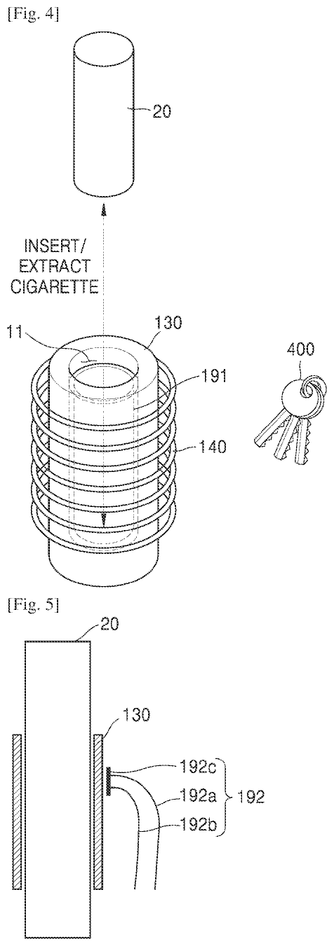

The controller 120 may prevent battery consumption and overload of internal components of the aerosol generating device 10 due to abnormal heating by cutting off power supplied to the induction coil 140 according to the first abnormal heating condition and the second abnormal heating condition. The detailed method by which the controller 120 determines abnormal heating will be described below with reference to FIG. 4.

According to an embodiment, the aerosol generating device 10 may further include a communication interface for communicating with an external device, in addition to the components of FIG. 3. The communication interface may be implemented in a form supporting at least one communication method from among various types of digital interfaces, AP-based Wi-Fi (e.g., Wi-Fi, wireless local area network (WLAN)), Bluetooth, Zigbee, wired/wireless LAN, a wide area network (WAN), Ethernet, IEEE 1394, a high definition multimedia interface (HDMI), a universal serial bus (USB), MHL, AES/EBU, optical, Coax, and the like. In addition, the communication interface may include a transition minimalized differential signaling (TMDS) channel for transmitting video and audio signals, a display data channel (DDC) for transmitting and receiving device information and information related to video or audio (e.g., enhanced extended display identification data (E-EDID), and consumer electronic control (CEC) for transmitting and receiving a control signal. However, the communication interface is not limited thereto, and may be implemented as various types of interfaces.

FIG. 4 is a view illustrating an arrangement of a substrate detection sensor according to an embodiment.

Referring to FIG. 4, a susceptor 130 has a cylindrical shape and is arranged to induction heat an aerosol generating substrate 20 accommodated in a cavity 11.

An induction coil 140 is arranged outside the susceptor 130 in a longitudinal direction of the susceptor 130. The induction coil 140 may be supplied with power under control of the controller 120 to generate an alternating magnetic field and induction heat the susceptor 130.

The substrate detection sensor 191 is arranged in a region between the susceptor 130 and the induction coil 140. A length of the substrate detection sensor 191 may be longer than a length of the susceptor 130, and the susceptor 130 may be arranged to be included within the length in which the substrate detection sensor 191 is arranged, but is not limited thereto.

An inductance of the substrate detection sensor 191 may be varied by an electromagnetic induction material adjacent to the substrate detection sensor 191. The inductance of the substrate detection sensor 191 may be varied by an electromagnetic inductor included in the aerosol generating substrate 20. When a value of a change in inductance of the substrate detection sensor 191 is greater than or equal to a preset threshold inductance, the controller 120 may induction heat the susceptor 130 without a user input. However, even when an object 400 including an electromagnetic induction material is adjacent to the substrate detection sensor 191, the susceptor 130 may be heated. In other words, when the value of the change in inductance due to the object 400 is greater than or equal to the preset threshold inductance, the susceptor 130 may be heated contrary to an intention of a user even when the aerosol generating substrate 20 is not inserted into the cavity 11. The unintended heating may increase power consumption of the aerosol generating device 10 and weaken the durability of the internal components.

The aerosol generating device 10 of the disclosure may determine whether or not an abnormal heating condition is satisfied, to determine an error in detection of the aerosol generating substrate 20. The abnormal heating condition for determining the error in detection of the aerosol generating substrate 20 may be referred to as a first abnormal heating condition to be distinguished from an abnormal heating condition described below. In addition, the abnormal heating condition described below may be set to determine an error in detection of a temperature sensor and may be referred to as a second abnormal heating condition.

The controller 120 may determine whether or not the first abnormal heating condition is satisfied, on the basis of the detection information of the temperature sensor 192. The controller 120 may determine whether or not the first abnormal heating condition is satisfied, on the basis of a heating rate of a temperature of the susceptor 130. The heating rate (° C./sec) may be defined as an amount of a change in temperature of the susceptor 130 during a preset time.

A heating rate when the aerosol generating substrate 20 is not inserted into the cavity 11 may be higher than a heating rate when the aerosol generating substrate 20 is inserted into the cavity 11. The heating rate is changed because the aerosol generating substrate 20 functions as a load of the susceptor 130. In other words, a case in which the aerosol generating substrate 20 is inserted into the cavity 11 may correspond to a no-load state, and a case in which the aerosol generating substrate 20 is not inserted into the cavity 11 may correspond to a load state. The aerosol generating device 10 may more quickly heat the susceptor 130 in the no-load state.

The memory 160 may store a threshold value to prevent the susceptor 130 from being heated while the aerosol generating substrate 20 is not inserted into the cavity 11. The threshold value may refer to a threshold heating rate. The threshold heating rate may be set on the basis of a normal heating rate of the susceptor 130 while the aerosol generating substrate 20 is inserted into the cavity 11. The threshold heating rate may be determined by an experiment.

The controller 120 may determine whether or not the first abnormal heating condition is satisfied, on the basis of the threshold heating rate. When the heating rate of the susceptor 130 is greater than the threshold heating rate, the controller 120 may determine that the first abnormal heating condition is satisfied. In other words, when the temperature of the susceptor 130 reaches a preset heating temperature within a preset reference time, the controller 120 may cut off power supplied to the induction coil 140.

The aerosol generating device 10 of the disclosure may detect whether or not the aerosol generating substrate 20 is inserted, by using only the temperature sensor 192 without an additional component. In addition, the aerosol generating device 10 of the disclosure may minimize power consumption and increase the durability of the internal components by preventing the susceptor 130 from being unintentionally heated while the aerosol generating substrate 20 is not inserted into the cavity 11.

FIG. 5 is a view illustrating an arrangement of a temperature sensor according to an embodiment.

Referring to FIG. 5, a temperature sensor 192 may be implemented as a thermocouple. The temperature sensor 192 may include a first wire 192a, a second wire 192b, and a contact element 192c contacting the first wire 192a and the second wire 192b.

The first wire 192a and the second wire 192b may be formed of different types of metal and may be provided through calibration of various metal pairs for a thermocouple. The first wire 192a and the second wire 192b may be provided in the form of a ground type, a non-ground type, an exposed type, and a bead wire.

The first wire 192a and the second wire 192b may be spaced apart from each other to contact the contact element 192c. One end of the first wire 192a may contact the contact element 192c, and the other end of the first wire 192a may contact the controller 120. One end of the second wire 192b may contact the contact element 192c, and the other end of the second wire 192b may contact the controller 120. According to an embodiment, the other end of each of the first wire 192a and the second wire 192b may contact another metal material other than the controller 120.

The contact element 192c may contact an outer circumferential surface of a susceptor 130. The contact element 192c may include a conductive material and may conduct electricity.

When the first wire 192a and the second wire 192b form a closed circuit through the contact element 192c, an electromotive force may be generated due to a change in temperature of the contact element 192c. The electromotive force may be used as a sensing value for detecting the temperature of the susceptor 130. A temperature at the contact element 192c contacting the susceptor 130 may be detected as the temperature of the susceptor 130.

The temperature sensor 192 may include a converter that converts an analog sensing value into a digital sensing value, and the temperature sensor 192 may transmit the sensing value to the controller 120. The memory 160 may store a matching table of digital sensing values and susceptor temperature, and the controller 120 may determine the temperature of the susceptor 130 from the matching table stored in the memory 160.

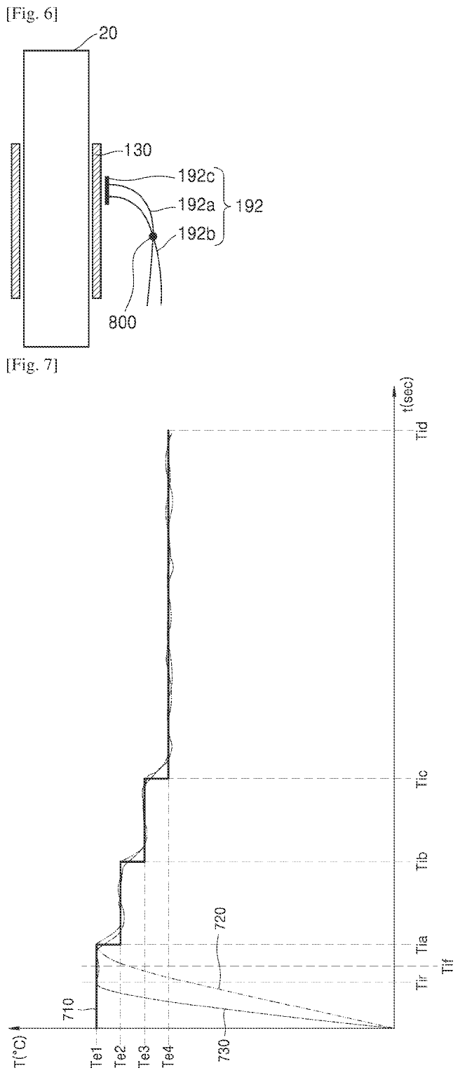

FIG. 6 is a view illustrating an error in a temperature sensing value according to an embodiment.

Referring to FIG. 6, as in FIG. 5, a temperature sensor 192 detects a temperature at a contact element 192c according to formation of a closed circuit by the contact element 192c. However, an electrical contact of the temperature sensor 192 may be generated at a different location from a susceptor 130 due to a manufacturing process or use. FIG. 6 illustrates an example in which an electrical contact is generated at a different location from the susceptor 130. However, the location of the electrical contact in FIG. 6 is only an example, and the generation location of the electrical contact may be different according to the manufacturing process or use.

FIG. 6 illustrates an example in which an electrical contact 800 of the temperature sensor 192 is generated to be spaced apart from the susceptor 130. As illustrated in FIG. 6, when the electrical contact 800 is generated to be space apart from the susceptor 130, the temperature sensor 192 may not detect an exact temperature of the susceptor 130. For example, as shown in FIG. 6, when the electrical contact 800 is generated to be spaced apart from the susceptor 130, the temperature sensor 192 provides the controller 120 with a temperature at the electrical contact 800. The controller 120 controls power supplied to the induction coil 140 on the basis of the temperature at the electrical contact 800.

Meanwhile, a heat source of the aerosol generating device 10 corresponds to the susceptor 130, and thus, when the electrical contact 800 is generated at a location other than the susceptor 130 or the contact element 192c, a temperature detected by the temperature sensor 192 becomes lower than the temperature at the susceptor 130 or the contact element 192c. In other words, a first temperature detected by the temperature sensor 192 may be lower than a second temperature that is an actual temperature of the susceptor 130. The controller 120 is provided with the first temperature at which the electrical contact 800 is generated, rather than the actual temperature of the susceptor 130, and thus, excessive power may be supplied to the induction coil 140. The supply of the excessive power may increase power consumption of the aerosol generating device 10 and weaken the durability of the internal components.

When the excessive power is supplied to the induction coil 140, the aerosol generating device 10 of the disclosure may cut off the power supplied to the induction coil 140 by determining the supply of the excessive power as abnormal heating.

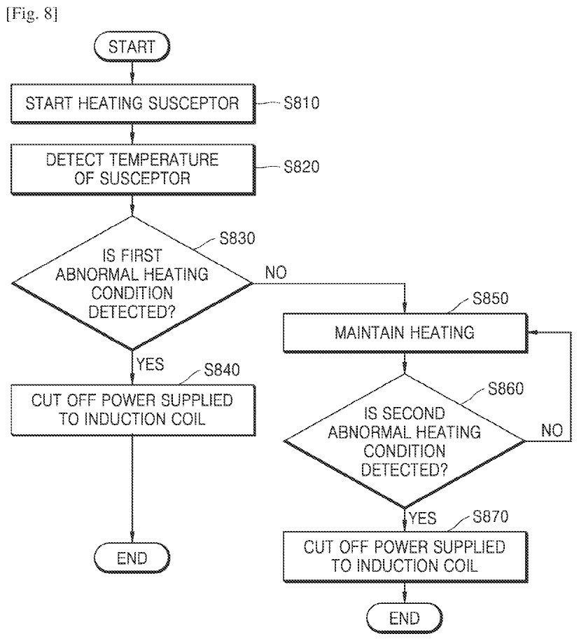

The controller 120 may determine whether or not a second abnormal heating condition is satisfied, to determine an error in detection by the temperature sensor 192. The controller 120 may determine whether or not the second abnormal heating condition is satisfied, on the basis of detection information of the temperature sensor 192. When the detection information of the temperature sensor 192 does not correspond to a preset temperature profile, the controller 120 may determine whether or not the second abnormal heating condition is satisfied. The preset temperature profile will be described in more detail with reference to FIG. 7, and may be stored in the memory 160.

The second abnormal heating condition may include a first sub-condition and a second sub-condition. When at least one of the first sub-condition and the second sub-condition is satisfied, the controller 120 may cut off the power supplied to the induction coil 140. The first sub-condition may be a temperature condition, and the second sub-condition may be a power condition.

When the electrical contact 800 is generated at a location other than the susceptor 130 or the contact element 192c, a temperature detected by the temperature sensor 192 may be lower than the temperature at the susceptor 130 or the contact element 192c. When a temperature acquired from the temperature sensor 192 within a preset monitoring time is lower than or equal to a preset maintenance temperature, the controller 120 may determine that the first sub-condition is satisfied. When the first sub-condition is detected, the controller 120 may cut off power supplied to the induction coil 140. The preset maintenance temperature may be set to be lower than a target temperature according to a temperature profile. The maintenance temperature may be set to be lower than the target temperature to increase user convenience by maintaining power supplied to the induction coil 140 in the case of a fine control error rather than an error in the temperature sensor 192.

When the electrical contact 800 is generated at the location other than the susceptor 130 or the contact element 192c, the temperature detected by the temperature sensor 192 is lower than the temperature at the susceptor 130 or the contact element 192c, and thus, the controller 120 may supply the induction coil 140 with more power than target power according to the temperature profile. When power detected by the power detection sensor 193 within the preset monitoring time is greater than or equal to preset reference power, the controller 120 may determine that the second sub-condition is satisfied. When the second sub-condition is detected, the controller 120 may cut off the power supplied to the induction coil 140. The preset reference power may be set to be higher than the target power according to the temperature profile. The reference power may be set to be higher than the target power to increase user convenience by maintaining the power supplied to the induction coil 140 in the base of the fine control error rather than the error in the temperature sensor 192.

When at least one of the first sub-condition and the second sub-condition is detected, the aerosol generating device 10 of the disclosure may minimize power consumption and increase the durability of the internal components by cutting off power supplied to the induction coil 140 to prevent the susceptor 130 to be unintentionally heated due to an error in detection by the temperature sensor 192.

FIG. 7 is a graph illustrating points in time of determining a first abnormal heating condition and a second abnormal heating condition, according to an embodiment.

FIG. 7 illustrates a temperature profile of the susceptor 130 according to an embodiment. The temperature profile may include information regarding a target temperature 710 over time. However, the temperature profile of the susceptor 130 is not limited to FIG. 7. A heating time, a target temperature, a target power amount, and the like may be set differently according to the design.

The controller 120 may heat the susceptor 130 on the basis of a first target temperature Te1 during a first time Tia. A temperature of the susceptor 130 may reach the first target temperature Te1 within a predetermined time Tif under control of the controller 120. For example, the first time Tia may be set in a range of about 20 seconds to about 40 seconds, and the first target temperature Te1 may be set in a range of about 276° C. to about 300° C.

The controller 120 may heat the susceptor 130 on the basis of a second target temperature Te2 lower than the first target temperature Te1 from the first time Tia to a second time Tib. The temperature of the susceptor 130 may be lowered to the second target temperature Te2 under control of the controller 120. For example, a difference between the second time Tib and the first time Tia may be set in a range of about 10 seconds to about 15 seconds, and the second target temperature Te2 may be set in a range of about 230° C. to about 275° C.

In an embodiment, a preheating section may include the first time Tia and the second time Tib. In addition, the first time Tia may be referred to as a first sub-preheating section, and a section from the first time Tia to the second time Tib may be referred to as a second sub-preheating section. The preheating section may refer to a section in which the temperature of the susceptor 130 increases and decreases to an appropriate temperature at which aerosol is generated. In addition, the preheating section may refer to a section in which actual puffs are not performed by a user.

The controller 120 may heat the susceptor 130 on the basis of a third target temperature Te3 lower than the second target temperature Te2 from the second time Tib to a third time Tic. The temperature of the susceptor 130 may be lowered to the third target temperature Te3 under control of the controller 120. For example, a difference between the third time Tic and the second time Tib may be set in a range of about 10 seconds to about 15 seconds, and the third target temperature Te3 may be set in a range of about 220° C. to about 268° C.

The controller 120 may heat the susceptor 130 on the basis of a fourth target temperature Te4 lower than the third target temperature Te3 from the third time Tic to a fourth time Tid. The temperature of the susceptor 130 may be lowered to the fourth target temperature Te4 under control of the controller 120. For example, a difference between the fourth time Tid and the third time Tic may be set in a range of about 50 seconds to about 220 seconds, and the fourth target temperature Te4 may be set in a range of about 210° C. to about 257° C.

In an embodiment, a smoking section may include the third time Tic and the fourth time Tid. The smoking section may refer to a section in which the temperature of the susceptor 130 is maintained at a target temperature, for puffs by the user. Also, the smoking section may refer to a section in which puffs are actually performed by the user.

The controller 120 may determine, in at least a partial section of the preheating section, whether or not a first abnormal heating condition is satisfied. In an embodiment, the controller 120 may determine, in an initial preheating section, whether or not the first abnormal heating condition is satisfied. For example, the controller 120 may determine whether or not the first abnormal heating condition is satisfied, in a first sub-preheating section after the susceptor 130 starts to be heated. The determination of whether or not the first abnormal heating condition is satisfied is made in the initial preheating section because the most significant difference in a heating rate of the susceptor 130 according to whether or not the aerosol generating substrate 20 is present occurs in the initial preheating section. In addition, the determination of whether or not the first abnormal heating condition is satisfied is made in the initial preheating section to significantly reduce power consumption by cutting off power supplied to the induction coil 140 before entering the smoking section when the aerosol generating substrate 20 is not inserted.

FIG. 7 illustrates information 720 regarding a temperature of the susceptor 130 when the aerosol generating substrate 20 is inserted into the cavity 11 and information 730 regarding a temperature of the susceptor 130 when the aerosol generating substrate 20 is not inserted into the cavity 11. FIG. 7 illustrates that a temperature sensor is in a normal state. In other words, in the temperature sensor 192, an electrical contact as shown in FIG. 6 may not be spaced apart from the susceptor 130.

A case in which the aerosol generating substrate 20 is not inserted into the cavity 11 corresponds to a no-load state, and thus, the temperature of the susceptor 130 may increase rapidly. The controller 120 may determine abnormal heating of the susceptor 130 according to the first abnormal heating condition. When a temperature acquired from the temperature sensor 192 within a preset reference time Tif reaches a preset heating temperature, the controller 120 may determine that the first abnormal heating condition is satisfied.

The preset reference time Tif may be experimentally set on the basis of a time for the temperature of the susceptor 130 reaches an initial preheating temperature while the aerosol generating substrate 20 is inserted into the cavity 11. Here, the initial preheating temperature may refer to the first target temperature Te1. In an embodiment, when the aerosol generating substrate 20 is inserted into the cavity 11, the time for the temperature of the susceptor 130 reaches the first target temperature Te1, which is the initial preheating temperature, may be the first time Tia. For example, the first target temperature Te1 may be 276° C. selected in a range of about 276° C. to about 300° C., and the first time Tia may be 20 seconds set in a range of about 20 seconds to about 40 seconds.

The preset reference time Tif may be set to be shorter than the first time Tia. For example, the preset reference time Tif may be set to be 10 seconds less than the first time Tia. In addition, the heating temperature may be set to be equal to the initial preheating temperature. In other words, the heating temperature may be set to be equal to the first target temperature Te1.

Referring to FIG. 7, when the aerosol generating substrate 20 is not inserted into the cavity 11, the temperature of the susceptor 130 reaches the first target temperature Te1, which is the heating temperature, for a time (e.g., 5 seconds) earlier than the reference time Tif, and thus, the controller 120 may determine that the first abnormal heating condition is satisfied. In other words, the controller 120 may cut off power supplied to the induction coil 140 by determining that the aerosol generating substrate 20 is not inserted into the cavity 11.

The controller 120 may determine, in the preheating section and the smoking section, whether or not a second abnormal heating condition is satisfied. The determination of whether or not the second abnormal heating condition is satisfied is made in all sections of the preheating section and the smoking section because a difference between actual and measured temperatures of the susceptor 130 according to the abnormality of the temperature sensor 192 does not significantly shows according to a heating section.

The second abnormal heating condition may include a first sub-condition that is a temperature condition and a second sub-condition that is a power condition.

When a temperature acquired from the temperature sensor 192 within a preset monitoring time is less than or equal to a preset maintenance temperature, the controller 120 may determine that the first sub-condition is satisfied. The preset maintenance temperature may be set on the basis of a temperature profile stored in the memory 160.

In an embodiment, the preset monitoring time may be set to be greater than the preset reference time Tif for determining the first abnormal heating condition. In other words, the preset monitoring time may be set to be greater than the preset reference time Tif to prevent a great difference between the target temperature and actual temperature of the susceptor 130 in the initial preheating section and prevent collision with the first abnormal heating condition. For example, the monitoring time may be set to 20 seconds, but is not limited thereto.

In an embodiment, the maintenance temperature may be set to be lower than the target temperature according to the temperature profile. The maintenance temperature may be set to be lower than the target temperature to increase user convenience by maintaining power supplied to the induction coil 140 in the case of the fine control error rather than the error in the temperature sensor 192. For example, the maintenance temperature may be set to be about 10° C. to about 20° C. lower than the target temperature.

When detecting the first sub-condition, the controller 120 may cut off the power supplied to the induction coil 140.

When power acquired from the power detection sensor 193 within the preset monitoring time is greater than or equal to preset reference power, the controller 120 may determine that the second sub-condition is satisfied. The determination of the second sub-condition may be performed simultaneously or at a different time from the determination of the first sub-condition.

In an embodiment, the monitoring time for determining the second sub-condition may be the same as the monitoring time for determining the first sub-condition.

In an embodiment, the preset reference power may be set on the basis of a power profile according to the target temperature. The preset reference power may be set to be higher than target power according to the power profile. The target power may refer to power supplied to the induction coil 140 to allow the temperature of the susceptor 130 to reach the target temperature when the temperature sensor 192 is in a normal state. The preset reference power may be set to be higher than the target power to increase user convenience by maintaining the power supplied to the induction coil 140 in the case of the fine control error rather than the error in the temperature sensor 192. For example, the target power for allowing the susceptor 130 to reach the third target temperature Te3 for the third time Tic after the second time Tib may be set in a range of about 120 mA to about 130 mA, and the preset reference power may be set in a range of about 80 mA to about 90 mA.

When detecting the second sub-condition, the controller 120 may cut off the power supplied to the induction coil 140.

The aerosol generating device 10 of the disclosure may more accurately recognize a state in which the susceptor 130 is abnormally heated while the aerosol generating substrate 20 is not inserted into the cavity 11 and a state in which the susceptor 130 is abnormally heated due to an error in the temperature sensor 192, by distinguishably determining the first abnormal heating condition and the second abnormal heating condition.

FIG. 8 is a flowchart illustrating an operation method of an aerosol generating device, according to an embodiment.

Referring to FIG. 8, in operation S810, the controller 120 may start heating the susceptor 130.

The controller 120 may determine whether or not the aerosol generating substrate 20 is inserted into the cavity 11, on the basis of an amount of a change in inductance of the substrate detection sensor 191. The inductance of the substrate detection sensor 191 may be varied by the electromagnetic inductor included in the aerosol generating substrate 20 or the object 400 including an electromagnetic induction material, which is adjacent to the aerosol generating device 10. When a value of the change in inductance of the substrate detection sensor 191 is greater than or equal to a preset threshold inductance, the controller 120 may induction heat the susceptor 130 without a user input.

When the amount of the change in inductance of the substrate detection sensor 191 is greater than or equal to the preset threshold inductance, the controller 120 may induction heat the susceptor 130 on the basis of the first target temperature Te1.

In operation S820, the temperature sensor 192 may detect a temperature of the susceptor 130.

The temperature sensor 192 may be arranged adjacent to the susceptor 130 and provide a temperature sensing value to the controller 120. The controller 120 may determine abnormal heating of the susceptor 130 on the basis of detection information of the temperature sensor 192.

In operation S830, the controller 120 may determine whether or not a first abnormal heating condition is satisfied.

The first abnormal heating condition may refer to a condition for determining that the susceptor 130 is unintentionally heated while the aerosol generating substrate 20 is not inserted into the cavity 11.

The controller 120 may determine, in at least a partial section of a preheating section, whether or not the first abnormal heating condition is satisfied. In an embodiment, the controller 120 may determine, in an initial preheating section, whether or not the first abnormal heating condition is satisfied. For example, the controller 120 may determine whether or not the first abnormal heating condition is satisfied, in a first sub-preheating section after the susceptor 130 starts to be heated. The first sub-preheating section may be set within a range of about 20 seconds to about 40 seconds, but is not limited thereto.

When a temperature acquired from the temperature sensor 192 within the preset reference time Tif reaches a preset heating temperature, the controller 120 may determine that the first abnormal heating condition is satisfied. The preset heating temperature may be set to be equal to the first target temperature Te1 that is an initial preheating temperature. The preset reference time Tif may be set on the basis of the first time Tia taken for the temperature of the susceptor 130 to reach the first target temperature Te1 while the aerosol generating substrate 20 is inserted into the cavity 11. The preset reference time Tif may be set to be less than the first time Tia. For example, the preset reference time Tif may be set to be 10 seconds less than the first time Tia.

When the first abnormal heating condition is detected, in operation S840, the controller 120 may cut off power supplied to the induction coil 140.

When the first abnormal heating condition is detected, the controller 120 may prevent the aerosol generating device 10 from operating contrary to an intention of a user by determining that the aerosol generating substrate 20 is not inserted into the cavity 11 to immediately cut off the power supplied to the induction coil 140.

According to an embodiment, when cutting off the power supplied to the induction coil 140 according to the first abnormal heating condition, the controller 120 may control the output unit 18 to output a first user notification.

In operation S850, when the first abnormal heating condition is not detected, the controller 120 may maintain heating of the susceptor 130.

When the first abnormal heating condition is not detected, the controller 120 may maintain heating of the susceptor 130 by continuously supplying power to the induction coil 140.

In operation S860, the controller 120 may determine whether or not a second abnormal heating condition is satisfied while maintaining heating of the susceptor 130.

The second abnormal heating condition may refer to a condition for determining that the susceptor 130 is not controlled to an intended temperature due to an abnormality of the temperature sensor 192.

The controller 120 may determine, in a preheating section and a smoking section, whether or not the second abnormal heating condition is satisfied. In an embodiment, the controller 120 may determine whether or not the second abnormal heating condition is satisfied, in the remaining preheating section and smoking section other than a determination section for the first abnormal heating condition. The determination of whether or not the second abnormal heating condition is satisfied is made in the remaining preheating section and smoking section other than the determination section for the first abnormal heating condition because a monitoring time for determining whether or not the second abnormal heating condition is satisfied is set to be greater than the preset reference time Tif. For example, the monitoring time may be set to 20 seconds that is greater than the preset reference time Tif.

The second abnormal heating condition may include a first sub-condition and a second sub-condition. When at least one of the first sub-condition and the second sub-condition is satisfied, the controller 120 may determine that the second abnormal heating condition is satisfied.

When a temperature acquired from the temperature sensor 192 within a preset monitoring time is lower than or equal to a preset maintenance temperature, the controller 120 may determine that the first sub-condition is satisfied. The preset maintenance temperature may be set to be lower than each target temperature included in a temperature profile. For example, the preset maintenance temperature may be set to be about 10° C. to about 20° C. lower than each target temperature.

When power acquired from the power detection sensor 193 within the preset monitoring time is greater than or equal to preset reference power, the controller 120 may determine that the second sub-condition is satisfied. The preset reference power may be set to be higher than each target power included in a power profile.

The determination of the second sub-condition may be performed simultaneously or at a different time from the determination of the first sub-condition.

When the second abnormal heating condition is not detected, in operation S850, the controller 120 may maintain heating of the susceptor 130 by continuously supplying the power to the induction coil 140.

When the second abnormal heating condition is detected, in operation S870, the controller 120 may cut off the power supplied to the induction coil 140.

According to an embodiment, when cutting off the power supplied to the induction coil 140 according to the second abnormal heating condition, the controller 120 may control the output unit 18 to output a second user notification. Output patterns of the first user notification when the first abnormal heating condition is detected and the second user notification when the second abnormal heating condition is detected may be different from each other.

For example, when the output unit 180 is implemented as an LED that outputs visual information, the number of flashes, cycles, and colors of the first user notification and the second user notification may be set to be different from each other. As another example, when the output unit 180 is implemented as a haptic motor that outputs tactile information, the number of vibrations, cycles, and the like of the first user notification and the second user notification may be set to be different from each other. As another example, when the output unit 180 is implemented as an LED and a haptic motor, any one user notification may be output by the LED and the other user notification may be output by the haptic motor.

The aerosol generating device 10 of the disclosure may minimize power consumption and increase durability of internal components by immediately cutting off the power supplied to the induction coil 140 when abnormal heating of the susceptor 130 occurs due to errors in sensing values of sensors such as the substrate detection sensor 191 and the temperature sensor 192.

In addition, the aerosol generating device 10 of the disclosure may more accurately detect a sensor that causes abnormal heating by setting the first abnormal heating condition and the second abnormal heating condition to be different from each other.

One of ordinary skill in the art pertaining to the present embodiments may understand that various changes in form and details may be made therein without departing from the scope of the characteristics described above. The disclosed methods should be considered in a descriptive sense only and not for purposes of limitation. The scope of the disclosure is defined by the appended claims rather than by the foregoing description, and all differences within the scope of equivalents thereof should be construed as being included in the disclosure.

1. An aerosol generating device comprising:
a battery;
an induction coil configured to generate an alternating magnetic field based on power supplied from the battery;
a susceptor configured to heat an aerosol generating substrate by using heat generated by the alternating magnetic field;
a temperature sensor arranged adjacent to the susceptor and configured to output a temperature sensing value as detection information; and
a controller configured to cut off power supplied to the induction coil, according to a first abnormal heating condition and a second abnormal heating condition, which are based on the detection information of the temperature sensor.

2. The aerosol generating device of claim 1, wherein the controller is configured to control the power supplied to the induction coil, according to a temperature profile including a preheating section and a smoking section, and in at least a partial section of the preheating section, cut off the power supplied to the induction coil, based on the first abnormal heating condition.

3. The aerosol generating device of claim 2, wherein the controller is configured to cut off the power supplied to the induction coil, based on the second heating condition, in the preheating section and the smoking section.

4. The aerosol generating device of claim 1, wherein the controller is configured to cut off the power supplied to the induction coil, according to the first abnormal heating condition, when a temperature acquired from the temperature sensor within a preset reference time reaches a preset heating temperature.

5. The aerosol generating device of claim 1, wherein the second abnormal heating condition includes a first sub-condition and a second sub-condition, and the controller is configured to cut off the power supplied to the induction coil, when at least one of the first sub-condition and the second sub-condition is satisfied.

6. The aerosol generating device of claim 5, wherein the controller is configured to cut off the power supplied to the induction coil, according to the first sub-condition, when the temperature acquired from the temperature sensor is less than or equal to a preset maintenance temperature.

7. The aerosol generating device of claim 6, wherein the preset maintenance temperature is set to be lower than a target temperature of the susceptor according to a temperature profile.

8. The aerosol generating device of claim 5, wherein the controller is configured to cut off the power supplied to the induction coil, according to the second sub-condition, when the power supplied to the induction coil is greater than or equal to preset reference power.

9. The aerosol generating device of claim 8, wherein the preset reference power is set to be higher than target power to be supplied to the induction coil, to allow a temperature of the susceptor to reach a target temperature.

10. The aerosol generating device of claim 1, wherein the susceptor is formed to surround an outer circumferential surface of a cavity into which the aerosol generating substrate is inserted.

11. The aerosol generating device of claim 1, wherein the temperature sensor includes:
a first wire;
a second wire; and
a contact element contacting the first wire and the second wire.

12. The aerosol generating device of claim 11, wherein the first wire and the second wire are spaced apart from each other and in contact with the contact element, and the contact element is in contact with an outer circumferential surface of the susceptor.

13. The aerosol generating device of claim 1, further comprising a substrate detection sensor of which inductance varies when the aerosol generating substrate including an electromagnetic inductor is inserted into a cavity, wherein the controller is configured to determine whether or not the aerosol generating substrate is inserted into the cavity, on the basis of a detection result of the substrate detection sensor.

14. The aerosol generating device of claim 1, further comprising an output unit configured to output a first user notification and a second user notification, respectively, when the power supplied to the induction coil is cut off according to the first abnormal heating condition and the second abnormal heating condition.

15. The aerosol generating device of claim 14, wherein output patterns of the first user notification and the second user notification are set to be different from each other.
